(19) United States
(12) Patent Application Publication
(10) Pub. No.: US 2026/0189662 A1
(43) Pub. Date: Jul. 2, 2026

(54) INFORMATION PROCESSING SYSTEM, NON-TRANSITORY COMPUTER READABLE MEDIUM AND METHOD

(71) Applicant: FUJIFILM Business Innovation Corp., Tokyo (JP)

(72) Inventor: Kazutoshi SUZUKI, Kanagawa (JP)

(73) Assignee: FUJIFILM Business Innovation Corp., Tokyo (JP)

(21) Appl. No.: 19/193,227

(22) Filed: Apr. 29, 2025

(30) Foreign Application Priority Data
Dec. 27, 2024 (JP) 2024-232419

(51) Int. Cl. H04N 1/00; G06F 3/12

(52) U.S. Cl. CPC H04N 1/00456; G06F 3/1208

(57) ABSTRACT

An information processing system includes a processor configured to: acquire size information indicating a size of a drawing region of drawing data that is produced without designating an output paper sheet; acquire layout settings designated in printing the drawing data; and generate, in response to the size information and the layout settings, an advance confirmation image used to confirm, in advance, information on the output paper sheet on which the drawing data is to be printed, and information on a print area of the drawing data on the output paper sheet.

### CROSS-REFERENCE TO RELATED APPLICATIONS

This application is based on and claims priority under 35 USC 119 from Japanese Patent Application No. 2024-232419 filed Dec. 27, 2024.

### BACKGROUND

### (i) Technical Field

The present disclosure relates to an information processing system, a non-transitory computer readable medium and a method.

### (ii) Related Art

Japanese Unexamined Patent Application Publication No. 2006-092394 discloses a layout determination apparatus that determines a layout in printing an image. The layout determination apparatus receives a selection between a size designation and a position designation of a print area of the image to be printed. The layout determining apparatus receives the position designation of the print area when the selection of the position designation is received. The layout determination apparatus receives the size designation when the selection of the size designation is received. The layout determination apparatus determines the layout such that the image is printed in accordance with the position of the received printed area and size of the received print area.

Japanese Unexamined Patent Application Publication No. 2007-195065 discloses an image processing apparatus that displays on a display a print layout including at least one object image being edited. The image processing apparatus acquires information including a margin area of a paper sheet on which an image is to be printed. The image processing apparatus draws fixedly an image of the paper sheet. The image processing apparatus sets a layout position of the object image on a region indicating the drawn paper sheet. In accordance with acquired information on the margin area, the image processing apparatus draws the object image at the set layout position in a display format different between outside of the margin area and inside of the margin area.

Japanese Unexamined Patent Application Publication No. 2009-116735 discloses an information processing apparatus that performs preview of printing on a printer. The information processing apparatus includes a printer information acquisition unit that acquires information on settings on the printer. The information processing apparatus includes a print setting acquisition unit that acquires print settings. The information processing apparatus performs physical preview of a multiple-page document in accordance with information acquired by the printer information acquisition unit and print setting acquisition unit.

Drawing data produced without designating an output paper sheet may be printed at designated layout settings. In such a case, however, it is difficult to confirm in advance the information on the output paper sheet on which the drawing data is to be printed and the information on the print area of the drawing data on the output paper sheet.

### SUMMARY

Aspects of non-limiting embodiments of the present disclosure relate to confirming in advance information on an output paper sheet on which drawing data is to be printed and information on a print area of the drawing data on the output paper sheet when the drawing data produced without designating the output paper sheet is printed at designated layout settings.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: acquire size information indicating a size of a drawing region of drawing data that is produced without designating an output paper sheet; acquire layout settings designated in printing the drawing data; and generate, in response to the size information and the layout settings, an advance confirmation image used to confirm, in advance, information on the output paper sheet on which the drawing data is to be printed, and information on a print area of the drawing data on the output paper sheet.

### BRIEF DESCRIPTION OF THE DRAWINGS

Exemplary embodiments of the present disclosure will be described in detail based on the following figures, wherein:

FIG. 1 illustrates an example of the hardware configuration of an image forming apparatus according to exemplary embodiments;

FIG. 2 illustrates an example of the hardware configuration of the image forming apparatus according to the exemplary embodiments;

FIG. 3 illustrates an example of screens displayed by an image processing apparatus according to a first exemplary embodiment;

FIG. 4 illustrates an example of the functional configuration of the image processing apparatus according to the first exemplary embodiment;

FIG. 5 illustrates an example of the process of the image processing apparatus according to the first exemplary embodiment;

FIG. 6 illustrates an example of screens displayed in a first format by an image processing apparatus of a second exemplary embodiment;

FIG. 7 illustrates an example of screens displayed in a second format by the image processing apparatus according to the second exemplary embodiment;

FIG. 8 illustrates an example of the functional configuration of the image processing apparatus according to the second exemplary embodiment;

FIG. 9 illustrates an example of the process of the image processing apparatus according to the second exemplary embodiment;

FIG. 10 illustrates a specific example of an output format in which drawing data is hidden by folding according to a third exemplary embodiment;

FIG. 11 illustrates an example of screens displayed by the image processing apparatus according to the third exemplary embodiment;

FIG. 12 illustrates an example of the functional configuration of the image processing apparatus according to the third exemplary embodiment; and

FIG. 13 illustrates an example of the process of the image processing apparatus according to the third exemplary embodiment.

### DETAILED DESCRIPTION

Exemplary embodiments are described in detail with reference to the drawings.

### Overview of Exemplary Embodiments

The exemplary embodiments provide an information processing system. The information processing system acquires size information indicating the size of a drawing region of drawing data that is produced without designating an output paper sheet. The information processing system also acquire layout settings designated in printing the drawing data. The information processing system further generates, in accordance with the size information and layout settings, an advance confirmation image that is used to confirm in advance information on the output paper sheet on which the drawing data is to be printed and information on a print area of the drawing data on the output print paper sheet.

The term “system” herein may be configurated to include a single apparatus or multiple apparatuses. In the following discussion, the information processing system may be configurated to include, for example, a single apparatus. The single apparatus is, for example, an image processing apparatus.

### Hardware Configuration of Image Forming Apparatus

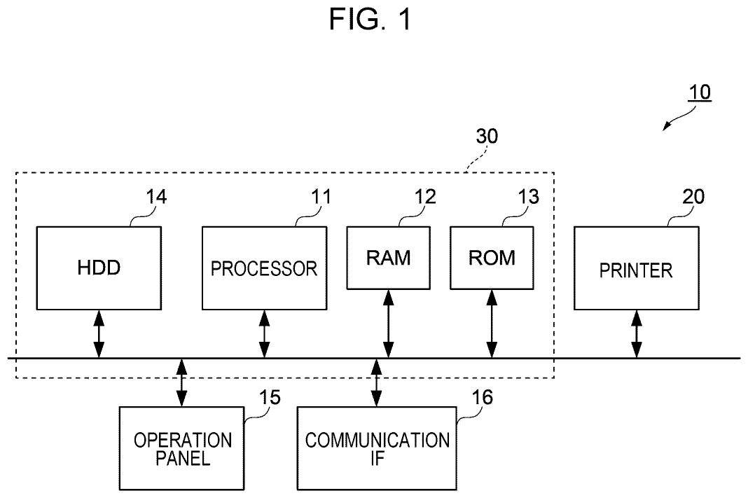

FIG. 1 illustrates an example of the hardware configuration of an image forming apparatus 10 according to exemplary embodiments. As illustrated in FIG. 1, the image forming apparatus 10 includes a processor 11. The image forming apparatus 10 further includes a random-access memory (RAM) 12, read-only memory (ROM) 13 and hard-disk drive (HDD) 14. The image forming apparatus 10 further includes an operation panel 15 and communication interface (IF) 16. The image forming apparatus 10 further includes a printer 20.

The processor 11 loads a variety of programs stored on the ROM 13 or the like onto the RAM 12. The processor 11 implements a variety of function described below by executing the programs.

The RAM 12 is used as a working memory or the like of the processor 11.

The ROM 13 stores a variety of programs, executed by the processor 11, or the like.

The HDD 14 is, for example, a magnetic disk that stores a variety of data. The variety of data includes print data used in printing performed by the printer 20.

An image processing apparatus 30 is configurated to include a section including the processor 11, RAM 12, ROM 13 and HDD 14.

An operation panel 15 is, for example, a touch panel that displays a variety of information and receives an operation input from a user. The operation panel 15 includes a display and a position detecting sheet. The display displays the variety of information. The position detecting sheet detects a position that is pointed to by a pointer, such as a finger or a stylus pen. Alternatively, the operation panel 15 may be a display and a keyboard rather than the touch panel.

The communication IF 16 exchanges the variety of information via a communication network with another apparatus, such as a host computer. The host computer is a higher-level device that transmits drawing data to the image forming apparatus 10. The drawing data is produced without designating an output paper sheet. The size of the drawing region of the drawing data does not match the size of the output paper sheet. The drawing data may be, for example, computer aided design (CAD) data.

The printer 20 prints an image on a recording medium, such as a paper sheet. the printer 20 may be an electrophotographic system or an ink-jet system. The electrophotographic system forms an image on the recording medium by transferring toner stuck on a photoconductor drum to the recording medium. The ink-jet system forms an image on the recording medium by ejecting ink on the recording medium.

### Hardware Configuration of Printer

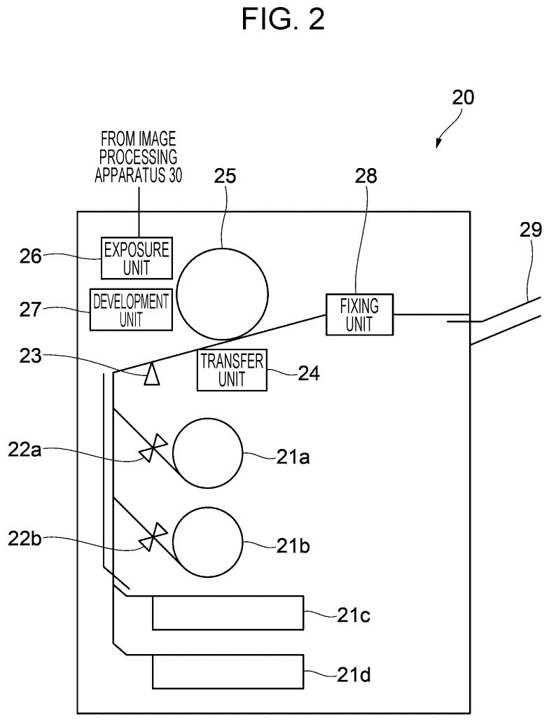

FIG. 2 illustrates an example of the hardware configuration of the printer 20 in the image forming apparatus 10 according to the exemplary embodiments.

As illustrated in FIG. 2, the printer 20 includes paper feeders 21a through 21d. The paper feeders 21a and 21b feed rolled paper sheets and the paper feeders 21c and 21d feeds cut paper sheets. The printer 20 includes cutters 22a and 22b that cut rolled paper sheets respectively fed by the paper feeders 21a and 21b. Any of the paper sheets rolled around the paper feeders 21a and 21b and the cut paper sheets in the paper feeders 21c and 21d is used for a print paper sheet. The paper sheet to be used is selected in response to an instruction from the image processing apparatus 30.

The selected print paper sheet is transported to a transfer unit 24 in response to an output instruction from the image processing apparatus 30. A paper stop sensor 23 detecting the arrival of the print paper sheet is arranged before the transfer unit 24. An exposure unit 26 performs an exposure operation on the surface of a transfer drum 25 that rotates at a predetermined speed. The exposure operation is performed in accordance with image data supplied from the image processing apparatus 30. In this way, the exposure unit 26 forms a latent image responsive to the image data on the surface of the transfer drum 25. A development unit 27 supplies toner to the surface of the transfer drum 25 having the latent image thereon. The development unit 27 thus forms a toner image responsive to the image data on the surface of the transfer drum 25. The transfer unit 24 presses the print paper sheet against the surface of the transfer drum 25, thereby transferring the toner image on the surface of the transfer drum 25 onto the print paper sheet. The print paper sheet having the transferred toner image thereon is discharged into a paper output tray 29 after having undergone a fixing operation of a fixing unit 28.

Each of the paper feeders 21a through 21d, if not differentiated from each other, may be referred to as a feeder 21. Each of the cutters 22a and 22b, if not differentiated from other, may also be referred to as a cutter 22.

### Problem of Image Processing Apparatus and Step Thereto

The image processing apparatus 30 determines an input size in accordance with size information indicating the size of a drawing region of the drawing data. The input size herein is the size of the drawing region that is determined in view of a margin or the like of the input size. The image processing apparatus 30 determines an output size in accordance with the input size and layout setting. The output size may be a standard size, a long size or an irregular size. In such a case, the image processing apparatus 30 provides a single layout setting responsive to the sizes of multiple drawing regions. The image processing apparatus 30 then determines an output format in response to the input size of the drawing region. Specifically, the image processing apparatus 30 determines the size and orientation of the output paper sheet and the size, position and orientation of the drawing data on the output data sheet.

The size of the drawing region of the drawing data transmitted from the host computer is larger than the paper sheet size expected to be output. The drawing data to be generated may be different in terms of the orientation and the origin of coordinates depending on CAD or the like. Through the layout settings, the image processing apparatus 30 provides outputs in view of a variety of sizes of the drawing region transmitted from the host computer. The user then outputs the drawing data, different in size of the drawing data, at a single layout setting and an assumed output format. The output format signifies the size and orientation of the output paper sheet, the size, position and orientation of the drawing data on the output paper sheet, and the like. In the outputs, layout settings including a size map, a roll map, centering and the like may affect each other in a complex fashion. The user has a difficulty in adjusting the layout settings.

According to the exemplary embodiments, the user may preview the output format of the drawing data on the operation panel 15. In this way, the user may confirm in advance whether the drawing data is output in the output format requested by the user.

### Image Processing Apparatus According to First Exemplary Embodiment

### Outline Process of Image Processing Apparatus

The image processing apparatus 30 according to a first exemplary embodiment performs an outline process as described below. In the following discussion, an image processing apparatus 100 serves as the image processing apparatus 30 according to the first exemplary embodiment.

The image processing apparatus 100 receives the input drawing data. The image processing apparatus 100 determines the size and orientation of the output paper sheet in accordance with the layout settings. The image processing apparatus 100 also determines the size, position and orientation of the drawing data on the output paper sheet. The image processing apparatus 100 previews on the operation panel 15 the size and orientation of the output paper sheet and the size, position and orientation of the drawing data.

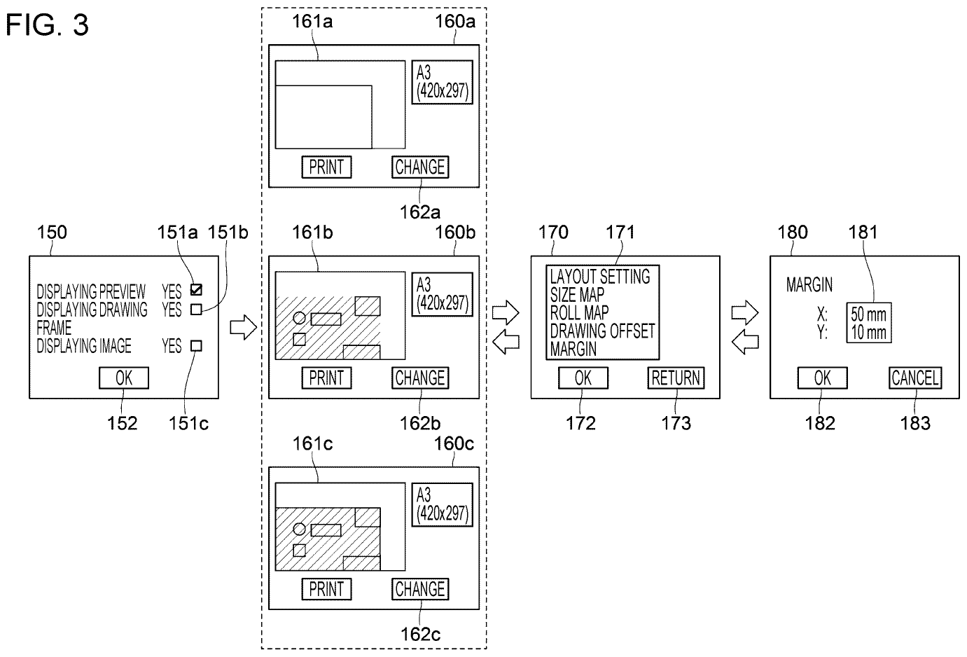

FIG. 3 illustrates an example of screens displayed by the image processing apparatus 100 according to the first exemplary embodiment.

Referring to FIG. 3, the image processing apparatus 100 displays a preview mode setting screen 150 on the operation panel 15. The user may check off any of check boxes 151a through 151c on the preview mode setting screen 150. The user may now check off at least the check box 151a and press an OK button 152.

The image processing apparatus 100 receives the drawing data from the host computer and processes the received drawing data. The image processing apparatus 100 then displays one of preview screens 160a through 160c on the operation panel 15.

The preview screen 160a displays a preview image 161a including only a drawing frame. When the user checks off check boxes 151a and 151b on the preview mode setting screen 150, the preview image 161a is displayed. The preview image 161a is an example of the advance confirmation image including an image of a frame of the drawing data.

The preview screen 160b displays a preview image 161b including only images. When the user checks off the check boxes 151a and 151c on the preview mode setting screen 150, the preview screen 161b is displayed. The preview image 161b is an example of the advance confirmation image including a print image of the drawing data.

The preview screen 160c displays a preview image 161c including a drawing frame and images. When the user checks off the check boxes 151a through 151c on the preview mode setting screen 150, the preview image 161c is displayed. The preview image 161c is an example of the advance confirmation image including the image of the drawing frame of the drawing data. The preview image 161c is an example of the advance confirmation image including a print image of the drawing data.

In this state, the user may now press one of change buttons 162a through 162c in this state.

The image processing apparatus 100 displays a layout setting change screen 170 on the operation panel 15. The layout setting change screen 170 incudes a layout setting selection region 171. The size map, roll map, drawing offset and margin are selectable within the layout setting selection region 171. For example, the user may now select the margin and then press an OK button 172.

The image processing apparatus 100 displays a margin setting screen 180 on the operation panel 15. The user has entered a margin of 50 mm in the X direction and a margin of 10 mm in the Y direction in a margin input region 181. In this state, the user may now press an OK button 182 or a cancel button 183. The image processing apparatus 100 displays the layout setting change screen 170 again.

The user may now press a return button 173 on the layout setting change screen 170. The image processing apparatus 100 displays the originally displayed screen out of the preview screens 160a through 160c.

### Functional Configuration of Image Processing Apparatus

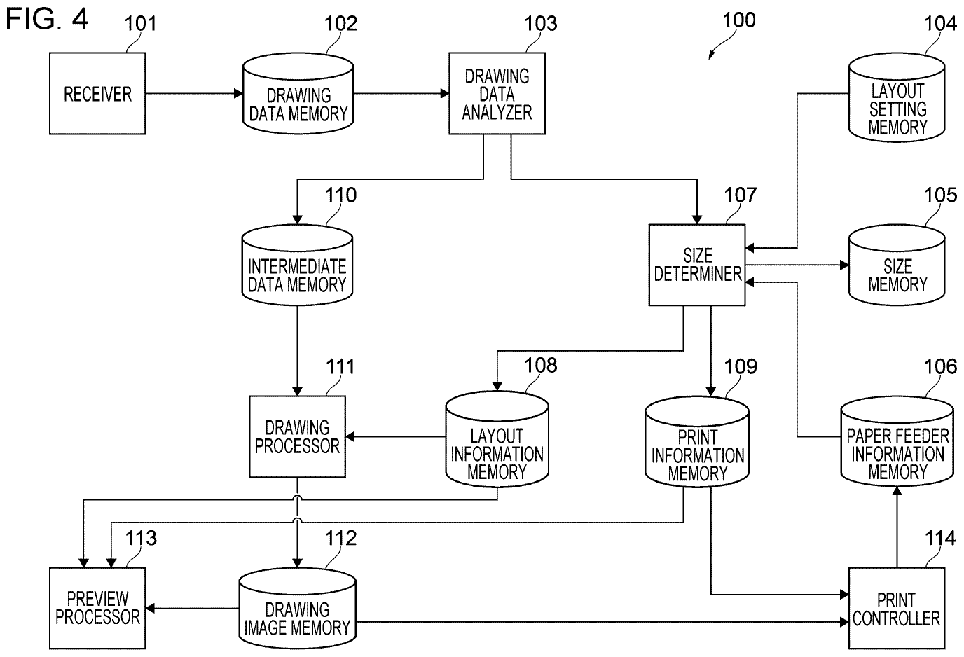

FIG. 4 illustrates the functional configuration of the image processing apparatus 100 according to the first embodiment. As illustrated in FIG. 4, the image processing apparatus 100 includes a receiver 101, drawing data memory 102 and drawing data analyzer 103. The image processing apparatus 100 further includes a layout setting memory 104, size memory 105 and paper feeder information memory 106. The image processing apparatus 100 further includes a size determiner 107, layout information memory 108 and print information memory 109. The image processing apparatus 100 further includes an intermediate data memory 110 and drawing processor 111. The image processing apparatus 100 further includes a drawing image memory 112, preview processor 113 and print controller 114.

The receiver 101 receives the drawing data transmitted from the host computer. The drawing data herein is assumed to be written in a variety of data formats. According to the first exemplary embodiment, the operation of the receiver 101 is an example of operation used to acquire the drawing data.

The drawing data memory 102 stores the drawing data received by the receiver 101.

The drawing data analyzer 103 analyzes the drawing data stored on the drawing data memory 102. The drawing data analyzer 103 converts the drawing data into intermediate data that is not dependent on data format. The drawing data analyzer 103 also acquire size information indicating the size of the drawing region of the drawing data. According to the first exemplary embodiment, the operation of the drawing data analyzer 103 is performed as an example of operation to acquire the size information.

The layout setting memory 104 stores layout settings. The layout settings are parameters used to determine the output format. The layout settings include the following parameters.

Firstly, the layout settings include input option. The input option is a parameter used to switch logics of size determination. The logic of the size determination includes determining whether the size is a standard size or a double-length size of the standard size. The logic of the size determination includes determining that a size in excess of the maximum size of the standard size is treated as a longer size and performing synchronized cutting. Furthermore, the logic of the size determination includes normally performing synchronized cutting.

Secondly, the layout settings include the size map. The size map is a parameter that designates a magnification of an output size responsive to an input size that is determined in accordance with the drawing data. The magnification may be designated depending on the input size. Setting that the output size is magnified to or reduced to an A2 size regardless of the input size is possible.

Thirdly, the layout settings include the roll map. The roll map is a parameter that designates the size of the rolled paper sheet or the cut paper sheet with respect to the output size.

The size memory 105 stores the size information on the drawing region in a print instruction output in the past. The size information is stored to preview a drawing image by designating a print instruction.

The paper feeder information memory 106 stores feeder information on the feeder 21 of the printer 20. The feeder information includes information on which of the rolled paper sheet or the cut paper sheet is contained in the feeder 21. If the cut paper sheet is contained in the feeder 21, the feeder information includes information on sheet size. If the rolled paper sheet is contained in the feeder 21, the feeder information includes information on roll width. The feeder information further includes information on a remaining amount and paper quality of paper in the feeder 21. The feeder information may be periodically acquired from the printer 20. Alternatively, the feeder information may be acquired from the printer 20 each time the size determiner 107 operates.

The size determiner 107 receives the size information on the drawing region from the drawing data analyzer 103. The size determiner 107 retrieves the layout settings from the layout setting memory 104. The size determiner 107 retrieves the feeder information from the paper feeder information memory 106. The size determiner 107 generates layout information and print information in accordance with the drawing region, layout settings and feeder information. The layout information includes information on the magnification, offset position, angle of rotation and the like used in a drawing operation. The print information includes instruction information on the printer 20, such as designation of the feeder 21 feeding paper sheet, designation of cut length of the rolled paper, and the like. The size determiner 107 stores on the size memory 105 the size information of the drawing region in association with the print instruction.

According to the first exemplary embodiment, the operation of the size determiner 107 is performed as an example of the operation to acquire the size information indicating the size of the drawing region of the drawing data. Also, according to the first exemplary embodiment, the operation of the size determiner 107 is performed as an example of the operation to acquire the layout settings designated in printing the drawing data.

The layout information memory 108 stores the layout information generated by the size determiner 107.

The print information memory 109 stores the print information generated by the size determiner 107.

The intermediate data memory 110 stores the intermediate data into which the drawing data analyzer 103 converts the drawing data.

The drawing processor 111 retrieves the intermediate data from the intermediate data memory 110. The drawing processor 111 retrieves the layout information from the layout information memory 108. The drawing processor 111 then performs on the intermediate data a magnification operation, adjustment operation of a drawing position, rotation operation, and the like in accordance with the layout information. The drawing processor 111 thus generates the drawing image. The drawing image herein is image data stored on a page memory.

The drawing image memory 112 stores the drawing image generated by the drawing processor 111.

The preview processor 113 retrieves the layout information from the layout information memory 108. The preview processor 113 retrieves the print information from the print information memory 109. The preview processor 113 retrieves the drawing image from the drawing image memory 112. The preview processor 113 generates a preview image in accordance with the layout information, print information and drawing image. The size, orientation, and print area of the output paper sheet may be recognized from the preview image. If the output paper sheet is a rolled paper sheet, the size and orientation of the output paper sheet are the size and cut length of the output paper sheet. In this way, the preview processor 113 displays the preview image on the operation panel 15.

According to the first exemplary embodiment, the preview image is used as an example of the advance confirmation image that is used to confirm in advance the information on the output paper sheet on which the drawing data is to be printed and the information on the print area of the drawing data on the output paper sheet. According to the first exemplary embodiment, the operation of the preview processor 113 is performed as an example of the operation to generate the advance confirmation image in response to the size information and the layout settings. Also, according to the first exemplary embodiment, the operation of the preview processor 113 is performed as an example of the operation to generate the advance confirmation image used to confirm in advance the size and orientation of the output paper sheet serving as the information on the output paper sheet. Furthermore, according to the first exemplary embodiment, the operation of the preview processor 113 is performed as an example of the operation to generate the advance confirmation image used to confirm in advance the size and cut length of the output paper sheet serving as the information on the output paper sheet. According to the first exemplary embodiment, the operation of the preview processor 113 is performed as an example of the operation to generate the advance confirmation image used to confirm in advance the orientation, magnification, and position in printing the drawing data on the output paper sheet serving as the information on the print area.

The print controller 114 retrieves the print information from the print information memory 109. The print controller 114 retrieves the drawing image from the drawing image memory 112. The print controller 114 then transmits the print information and drawing image to the printer 20. In this way, the print controller 114 controls the printer 20 such that the drawing image is printed on the paper sheet supplied from the designated feeder 21. If the paper sheet is a rolled paper sheet, the print controller 114 controls the printer 20 such that the cutter 22 cuts the paper sheet at the designated paper sheet length. The print controller 114 retrieves the feeder information on the feeder 21 from the printer 20. The print controller 114 then stores the feeder information on the paper feeder information memory 106.

### Detailed Process of Image Processing Apparatus

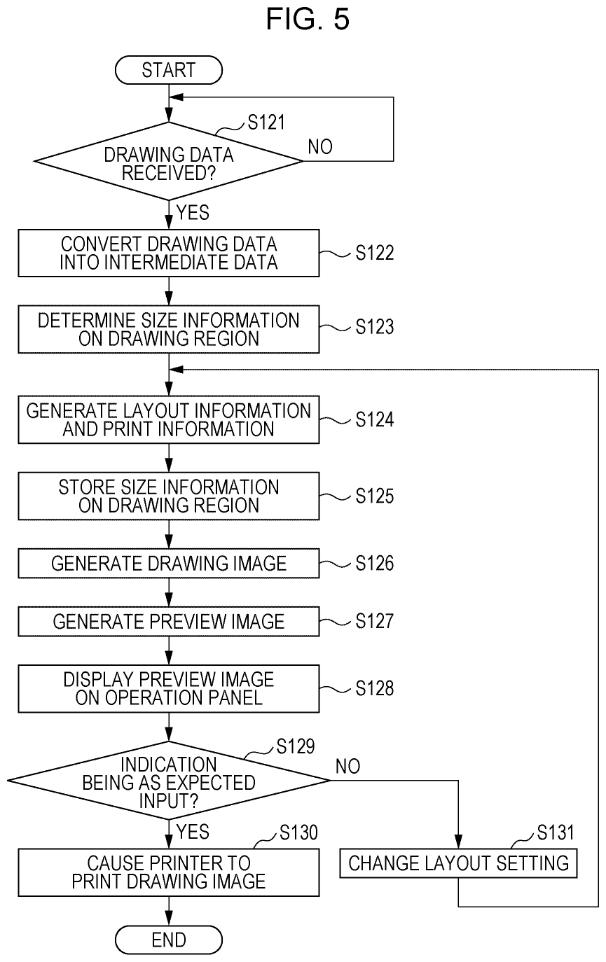

FIG. 5 is a flowchart illustrating the process of the image processing apparatus 100 according to the first exemplary embodiment.

Referring to FIG. 5, the image processing apparatus 100 first determines whether the receiver 101 has received the drawing data (step S121). If the drawing data has not been received in step S121, the receiver 101 repeats step S121. If the drawing data has been received in step S121, the drawing data is stored on the drawing data memory 102.

The drawing data stored on the drawing data memory 102 is analyzed by the drawing data analyzer 103. The drawing data analyzer 103 thus converts the drawing data into the intermediate data (step S122). The intermediate data is thus stored on the intermediate data memory 110. The drawing data analyzer 103 determines the size information on the drawing region (step S123).

The size determiner 107 generates the layout information and print information (step S124). Specifically, the size determiner 107 acquires the size information on the drawing region determined in step S123. The size determiner 107 retrieves the layout settings from the layout setting memory 104. The size determiner 107 retrieves the feeder information from the paper feeder information memory 106. The size determiner 107 generates the layout information and print information in accordance with those pieces of information. The layout information includes the magnification, offset position, angle of rotation and the like used when the drawing data is printed on the paper sheet. The layout information is stored on the layout information memory 108. The print information includes the information on the feeder 21 feeding the paper sheet in use, cut length of the rolled paper sheet when the paper sheet is the rolled paper sheet, and the like. The print information is stored on the print information memory 109.

The size determiner 107 stores the size information on the drawing region determined in step S123 (step S125). Specifically, the size determiner 107 stores on the size memory 105 the size information on the drawing region together with the print instruction.

The drawing processor 111 generates the drawing image (step S126). Specifically, the drawing processor 111 retrieves the intermediate data from the intermediate data memory 110. The drawing processor 111 retrieves the layout information from the layout information memory 108. The drawing processor 111 then performs a vector-raster conversion in accordance with the intermediate data and layout information. The drawing processor 111 generates the drawing image by writing a raster image onto a page memory. The drawing image is stored on the drawing image memory 112.

The preview processor 113 generates a preview image (step S127). Specifically, the preview processor 113 retrieves the layout information from the layout information memory 108. The preview processor 113 retrieves the print information from the print information memory 109. The preview processor 113 retrieves the drawing image from the drawing image memory 112. The preview processor 113 then generates the preview image from the layout information, print information and drawing image. In this way, the preview processor 113 displays on the operation panel 15 the preview image generated in step S127 (step S128). According to the first exemplary embodiment, the preview image includes the drawing image superimposed on the output paper sheet.

The image processing apparatus 100 determines whether an indication indicating that the preview image is as expected has been input on the operation panel 15 (step S129). If the indication indicating that the preview image is as expected has been input in step S129, the print controller 114 causes the printer 20 to print the preview image (step S130) and then ends the process. On the other hand, if the indication indicating that the preview image is not as expected has been input in step S129, the image processing apparatus 100 changes the layout settings in response to an instruction from the user (step S131) and returns to the operation in step S124.

### Image Processing Apparatus According to Second Exemplary Embodiment

### Outline Process of Image Processing Apparatus

According to the first exemplary embodiment, a single layout setting may output the drawing data of a variety of sizes. The user is thus free from changing all the layout settings. The user simply confirms the preview image and is free from actually outputting the paper sheet. However, the drawing data of each size may be actually prepared to confirm the output format of the size.

According to a first aspect of a second exemplary embodiment, the user may designate the size of the drawing region of the drawing data. The user may thus confirm the size and orientation of the output paper sheet and the size, position and orientation of the drawing data.

However, the user has difficulty in confirming the size of the drawing region of the drawing data transmitted from the host computer.

According to a second aspect of the second exemplary embodiment, the size of the drawing region of the drawing data may be designated using a past print instruction. Specifically, the size of the drawing region of printed drawing data associated with the print instruction is stored. By designating the print instruction, the user may thus confirm the size and orientation of the output paper sheet of the print instruction and the size, position and orientation of the drawing data.

The layout settings in the second aspect may be adjusted using the drawing data actually transmitted from the host computer. The layout settings may thus be efficiently adjusted.

The image processing apparatus 30 according to the second exemplary embodiment performs the following outline process. In the following discussion, the image processing apparatus 200 serves as the image processing apparatus 30 according to the second exemplary embodiment.

The image processing apparatus 200 in the first aspect receives the designation of the size of the drawing region. The image processing apparatus 200 determines the size and orientation of the output paper sheet in accordance with the layout settings. The image processing apparatus 200 also determines the size, position and orientation of the drawing data on the output paper sheet. The image processing apparatus 200 then previews on the operation panel 15 the size and orientation of the output paper sheet and the size, position and orientation of the drawing data on the output paper sheet. In this way, the user may confirm the output format responsive to the sizes of a variety of drawing regions.

The image processing apparatus 200 in the second aspect receives the designation of the print instruction in place of the size of the drawing region. The image processing apparatus 200 determines the size and orientation of the output paper sheet in accordance with the layout settings. The image processing apparatus 200 also determines the size, position and orientation of the drawing data on the output paper sheet in accordance with the layout settings. The image processing apparatus 200 then previews on the operation panel 15 the size and orientation of the output paper sheet and the size, position and orientation of the drawing data.

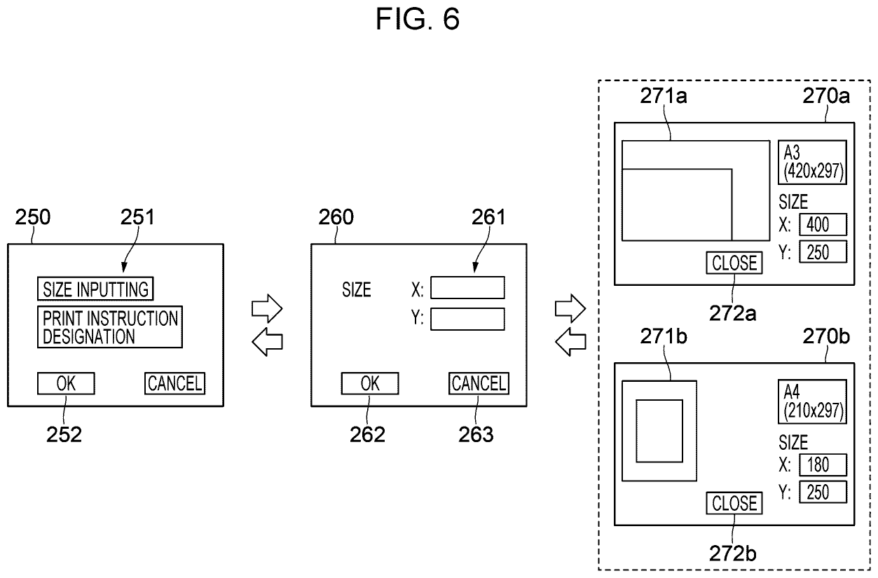

FIG. 6 illustrates an example of screens displayed by the image processing apparatus 200 in the first aspect of the second exemplary embodiment.

When a preview mode is started up, the image processing apparatus 200 displays an instruction selection screen 250 on the operation panel 15 as illustrated in FIG. 6. The user may select size inputting or print instruction designation on an instruction selection region 251. The user may now select the size inputting. In this state, the user may also select an OK button 252.

The image processing apparatus 200 then displays a size input screen 260 on the operation panel 15. The size input screen 260 is designed to enable the user to input the size in a size input region 261.

The user may now input on the size input region 261 a size “400” in the X direction and a size “250” in the Y direction. The user may now press an OK button 262. The image processing apparatus 200 then displays on the operation panel 15 a preview screen 270a including a preview image 271a. The preview image 271a indicates the size and orientation of the output paper sheet corresponding to the input size and the size, position and orientation of the drawing data. In this case, the input size indicates the size 400 in the X direction and the size 250 in the Y direction.

The user may now input on the size input region 261 a size “180” in the X direction and a size “250” in the Y direction. The user may now press the OK button 262. The image processing apparatus 200 then displays on the operation panel 15 a preview screen 270b including a preview image 271b. The preview image 271b indicates the size and orientation of the output paper sheet corresponding to the input size and the size, position and orientation of the drawing data. In this case, the input size indicates the size 180 in the X direction and the size 250 in the Y direction.

The user may press a close button 272a on a preview screen 270a or a close button 272b on a preview screen 270b. The image processing apparatus 200 then displays the size input screen 260 again.

The user may now press a cancel button 263 on the size input screen 260. The image processing apparatus 200 then displays the instruction selection screen 250 again.

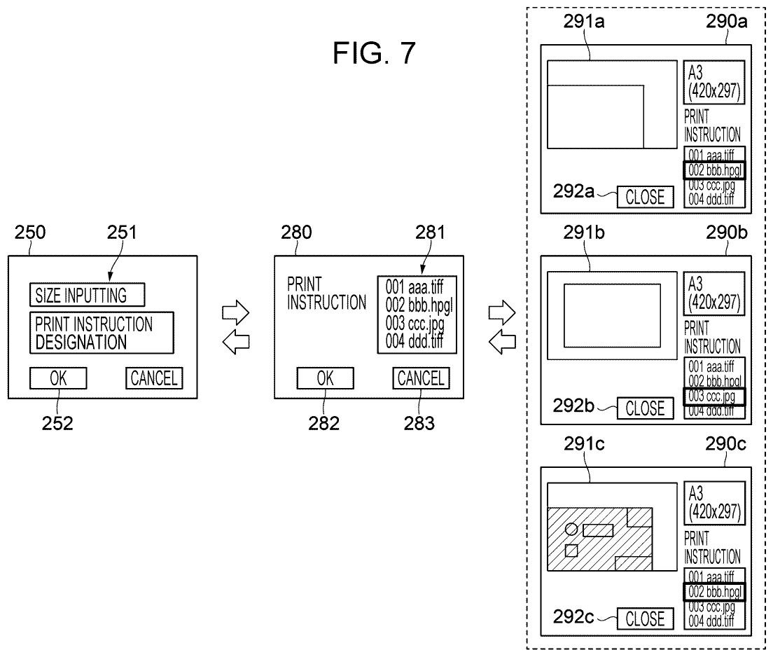

FIG. 7 illustrates an example of screens displayed by the image processing apparatus 200 in the second aspect of the second exemplary embodiment.

As illustrated in FIG. 7, the image processing apparatus 200 displays the instruction selection screen 250 on the operation panel 15 when the preview mode is started up. The instruction selection screen 250 is designed to enable the user to select the size inputting or print instruction designation on the instruction selection region 251. The user may now select the print instruction designation on the instruction selection region 251. In this state, the user may press the OK button 252.

The image processing apparatus 200 displays a print instruction designation screen 280 on the operation panel 15. The print instruction designation screen 280 is designed to enable the user to select a print instruction designated within a print instruction list region 281. A print instruction identification (ID) and a print instruction name are arranged in association with each other on the print instruction list region 281. The print instruction ID is identification information on the print instruction and is, for example, “001.” The print instruction name is the name of the print instruction and is, for example, “aaa.tiff.”

The user may now select the print instruction having the print instruction ID “002” on the print instruction list region 281. The user may press an OK button 282. The image processing apparatus 200 then displays on the operation panel 15 a preview screen 290a including a preview image 291a. The preview image 291a indicates the size and orientation of the output paper sheet corresponding to the designated size and the size, position and orientation of the drawing data. In this case, the designated size is associated with the print instruction identified by the print instruction ID 002.

The user may now select the print instruction identified by the print instruction ID “003” on the print instruction list region 281. The user may press the OK button 282. The image processing apparatus 200 then displays a preview screen 290b including a preview image 291b. The preview image 291b indicates the size and orientation of the output paper sheet corresponding to the designated size and the size, position and orientation of the drawing data. In this case, the designated size is associated with the print instruction identified by the print instruction ID 003.

The image processing apparatus 200 may store not only the size of the drawing region but also the drawing data themselves. In such a case, the image processing apparatus 200 displays a preview image having the drawing data arranged therewithin in place of a rectangle indicating the drawing region. A preview image 291c displayed on a preview screen 290c includes the drawing data arranged therewithin. The preview image 291c is displayed when the print instruction identified by the print instruction ID 002 is selected on the print instruction designation screen 280. The displaying of the drawing data could lead to a security issue. The user may thus be allowed to select whether or not the drawing data is displayed.

The user may now press a close button 292a on the preview screen 290a, a close button 292b on the preview screen 290b, or a close button 292c on the preview screen 290c. The image processing apparatus 200 then displays the print instruction designation screen 280 again.

The user may now press a cancel button 283 on the print instruction designation screen 280. The image processing apparatus 200 thus displays the instruction selection screen 250 again.

### Functional Configuration of Image Processing Apparatus

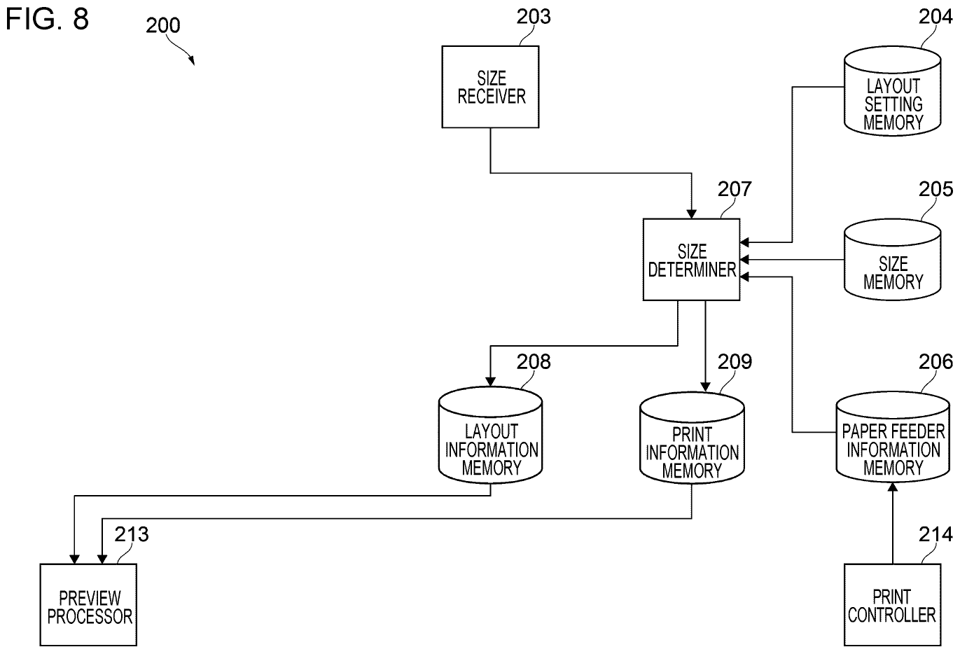

FIG. 8 is a block diagram illustrating the functional configuration of the image processing apparatus 200 according to the second embodiment. As illustrated in FIG. 8, the image processing apparatus 200 includes a size receiver 203. The image processing apparatus 200 further includes a layout setting memory 204, size memory 205 and paper feeder information memory 206. The image processing apparatus 200 further includes a size determiner 207, layout information memory 208 and print information memory 209. The image processing apparatus 200 further includes a preview processor 213 and print controller 214.

When the user inputs the size of the drawing region of the drawing data, the size receiver 203 receives size information indicating the size. According to the second exemplary embodiment, the operation of the size receiver 203 is performed as an example of the operation to acquire the size information in response to a user operation designating the size information.

The function of the layout setting memory 204 is identical to the function of the layout setting memory 104. The function of the size memory 205 is identical to the function of the size memory 105. The function of the paper feeder information memory 206 is identical to the function of the paper feeder information memory 106. The description of the functions of the layout setting memory 204, size memory 205 and paper feeder information memory 206 is thus not duplicated.

The size determiner 207 receives the size information on the drawing region from the size receiver 203. Alternatively, the size determiner 207 retrieves from the size memory 205 the size information on the drawing region in the past print instruction. The size determiner 207 retrieves the layout settings from the layout setting memory 204. The size determiner 207 retrieves the feeder information from the paper feeder information memory 206. The size determiner 207 generates the layout information and print information in accordance with the drawing region, layout settings and feeder information. The layout information includes information on a magnification, offset position, angle of rotation and the like used in a drawing operation. The print information includes instruction information on the printer 20, such as designation of the feeder 21 feeding paper sheet, designation of the cut length of the rolled paper when the rolled paper is used, and the like. The size determiner 207 stores on the size memory 205 the size information on the drawing region in association with the print instruction.

According to the second exemplary embodiment, the operation of the size determiner 207 is performed as an example of the operation to acquire the size information indicating the size of the drawing region of the drawing data. According to the second exemplary embodiment, the operation of the size determiner 207 is performed as an example of the operation to acquire the size information without acquiring the drawing data. According to the second exemplary embodiment, the operation of the size determiner 207 is further performed as an example of the operation to acquire the size information associated with the print data, selected by the user, out of the past print data. The operation of the size determiner 207 is performed as an example of the operation to acquire the layout settings designated in printing the drawing data.

The function of the layout information memory 208 is identical to the operation of the layout information memory 108. The function of the print information memory 209 is identical to the function of the print information memory 109. The description of the functions of the layout information memory 208 and print information memory 209 is thus not duplicated.

The preview processor 213 retrieves the layout information from the layout information memory 208. The preview processor 213 retrieves the print information from the print information memory 209. The preview processor 213 generates the preview image in accordance with the layout information and print information. The print information reveals the size, position and print area of the output paper sheet. If the output paper sheet is a rolled paper sheet, the size and orientation of the output paper sheet are respectively the size and cut length of the rolled paper sheet. The preview processor 213 thus displays the preview image on the operation panel 15.

The print controller 214 acquires the feeder information on the feeder 21 from the printer 20. The print controller 214 stores the feeder information on the paper feeder information memory 206.

### Detailed Process of Image Processing Apparatus

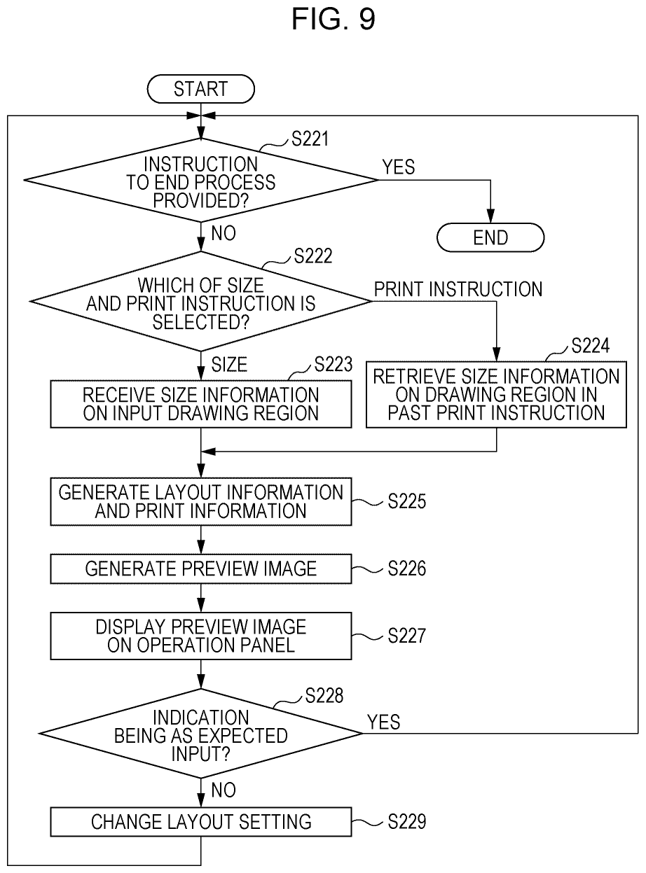

FIG. 9 is a flowchart illustrating an example of the process of the image processing apparatus 200 of the second exemplary embodiment.

As illustrated in FIG. 9, the image processing apparatus 200 determines whether an instruction to end the process has been provided (step S221). If the instruction to end the process has been provide in step S221, the image processing apparatus 200 ends the process.

If the instruction to end the process has not been provided in step S221, the image processing apparatus 200 determines which of the size inputting and print instruction designation is selected (step S222). The size inputting may now be selected. The size receiver 203 receives the size information on the drawing region input by the user (step S223). Alternatively, the print instruction designation may now be selected. The size determiner 107 retrieves form the size memory 105 the size information on the drawing region in the past print instructions (step S224).

The size determiner 207 generates the layout information and print information (step S225). Specifically, the size determiner 207 acquires the size information on the drawing region received in step S223 or retrieved in step S224. The size determiner 207 retrieves the layout settings from the layout setting memory 204. The size determiner 207 retrieves the feeder information from the paper feeder information memory 206. In accordance with these pieces of information, the size determiner 207 generates the layout information and print information. The layout information includes the magnification, offset position, angle of rotation and the like when the drawing data is printed on the paper sheet. The layout information is stored on the layout information memory 208. The print information includes the information on the feeder 21 feeding the paper sheet in use, cut length of the rolled paper sheet when the rolled paper sheet is used, and the like. The print information is stored on the print information memory 209.

The preview processor 213 generates the preview image (step S226). Specifically, the preview processor 213 retrieves the layout information from the layout information memory 208. The preview processor 213 retrieves the print information from the print information memory 209. The preview processor 213 generates the preview image from the layout information and print information. The preview processor 213 thus displays on the operation panel 15 the preview image generated in step S226 (step S227). According to the second exemplary embodiment, the preview image includes the output paper sheet but does not include the drawing image.

The image processing apparatus 200 determines whether an indication indicating that the preview image is as expected is received on the operation panel 15 (step S228). The indication indicating that the preview image is not as expected may now be received in step S228. The image processing apparatus 200 then changes the layout settings in response to a user instruction (step S229) and then returns to the operation in step S201. On the other hand, the indication indicating that the preview image is as expected may now be received in step S228. The image processing apparatus 200 then returns to the operation in step S201.

In the process, the user may switch between the size inputting and the print instruction designation. The disclosure is not limited to this method. The image processing apparatus 200 may be designed such that either the size inputting or the print instruction designation is performed.

### Image Processing Apparatus According to Third Exemplary Embodiment

### Outline Process of Image Processing Apparatus

The layout settings, if standard and free from a waste of paper, may be easily set. However, the layout settings, if slightly special, for example, attached with margins, may be difficult to be set as expected. There are times when the layout settings are difficult to support a variety of output formats on a per size basis of the drawing region. In such a case, outputting may be performed with logical printers switched.

According to a third exemplary embodiment, an external program may be built in a layout operation. The external program may designate the size and orientation of the output paper sheet and the size, position and orientation of the drawing data. The external program designates these pieces of information using the size information on the drawing region and the layout settings.

In this way, directly in accordance with the size of the drawing region from the layout settings, the user may designate the output format the user wants.

The external program may be configurated to be interchangeable. In this way, the layout settings supporting the output format the user wants may be implemented without being involved in a setting change at each time.

The image processing apparatus 30 according to the third exemplary embodiment performs the outline process described below. In the following discussion, an image processing apparatus 300 serves as the image processing apparatus 30 according to the third exemplary embodiment.

The image processing apparatus 300 performs the layout operation through the external program 350 instead of using the layout settings. The external program 350 acquires the size of the drawing region and designates the size and orientation of the output paper sheet and the size, position and orientation of the drawing data.

If the size of the drawing region is different, the image processing apparatus 300 may output, through a single external program, the drawing data in a variety of output formats the user wants.

The image processing apparatus 300 performs an operation to output the drawing data in an output format that causes the drawing data to be hidden by folding in half. In this output format, the drawing data is printed on the bottom half portion of a paper sheet having the area twice as large as the size of the drawing region and the paper sheet is then folded in half such that the drawing data is hidden. Note that if the size of the drawing region of the drawing data is larger than a size A1, the size is reduced by 50%.

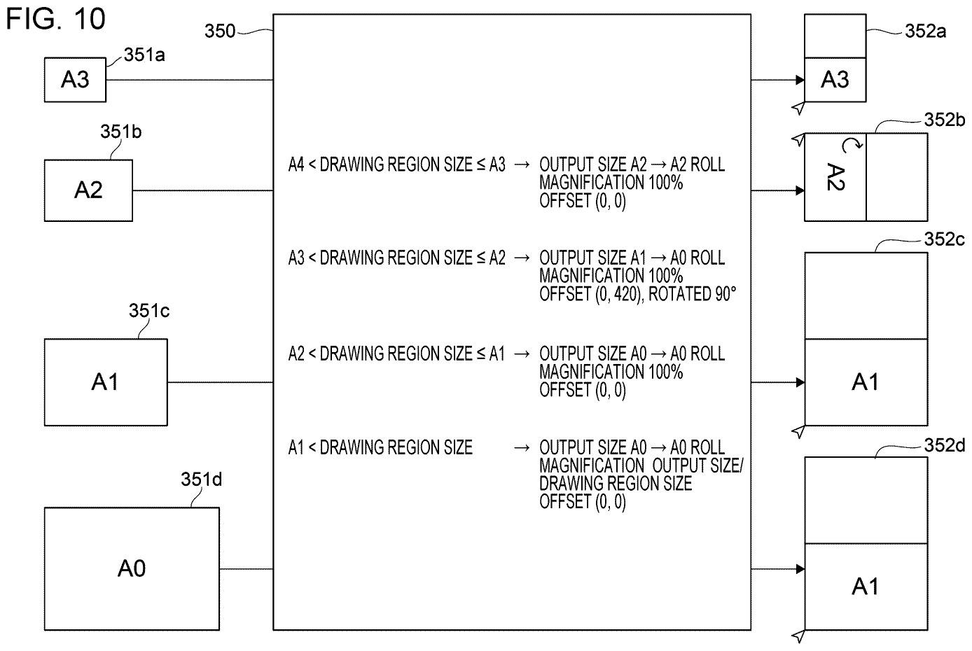

FIG. 10 illustrates a specific example when the drawing data is output in the output format described above. Note that only an A2 rolled paper sheet and A0 rolled paper sheet are contained in the feeders 21.

The external program 350 may now acquire drawing data 351a having the size of the drawing region larger than size A4 but equal to or smaller than size A3. Note that the drawing data 351a indicates an input size A3 determined by the size of the drawing region. In this case, the external program 350 determines the output size to be A2 and the output paper sheet to be the A2 scrolled paper sheet. The external program 350 also determines the magnification to be 100% and the offset position to be (0, 0). Specifically, the external program 350 thus determines the output format 352a.

The external program 350 may now acquire drawing data 351b having the size of the drawing region larger than size A3 but equal to or smaller than size A2. Note that the drawing data 351b indicates an input size A2 determined by the size of the drawing region. In this case, the external program 350 determines the output size to be A1 and the output paper sheet to be the A0 scrolled paper sheet. The external program 350 also determines the magnification to be 100%, the offset position to be (0, 420) and the angle of rotation to be 90 degrees. If the A1 rolled paper sheet is not present, an A0 rolled paper sheet is rotated and thus output, and the external program 350 thus determines an output format 352b.

The external program 350 may now acquire drawing data 351c having the size of the drawing region larger than size A2 but equal to or smaller than size A1. Note that the drawing data 351c indicates an input size A1 determined by the size of the drawing region. In this case, the external program 350 determines the output size to be A0 and the output paper sheet to be the A0 scrolled paper sheet. The external program 350 also determines the magnification to be 100% and the offset position to be (0, 0). The external program 350 thus determines an output format 352c.

The external program 350 may now acquire drawing data 351d having the size of the drawing region larger than size A1. Note that the drawing data 351d indicates an input size A0 determined by the size of the drawing region. In this case, the external program 350 determines the output size to be A0 and the output paper sheet to be the A0 scrolled paper sheet. The external program 350 also determines the magnification to be (output size/drawing region size) and the offset position to be (0, 0). The external program 350 thus determines an output format 352d.

The image processing apparatus 300 may perform the operation to output the drawing data in another output format. In another output format, the drawing data may be output to an A3 paper sheet with margins attached only when the size of the drawing data is A4.

According to the third exemplary embodiment, the image processing apparatus 300 may output the drawing data in a flexible output format.

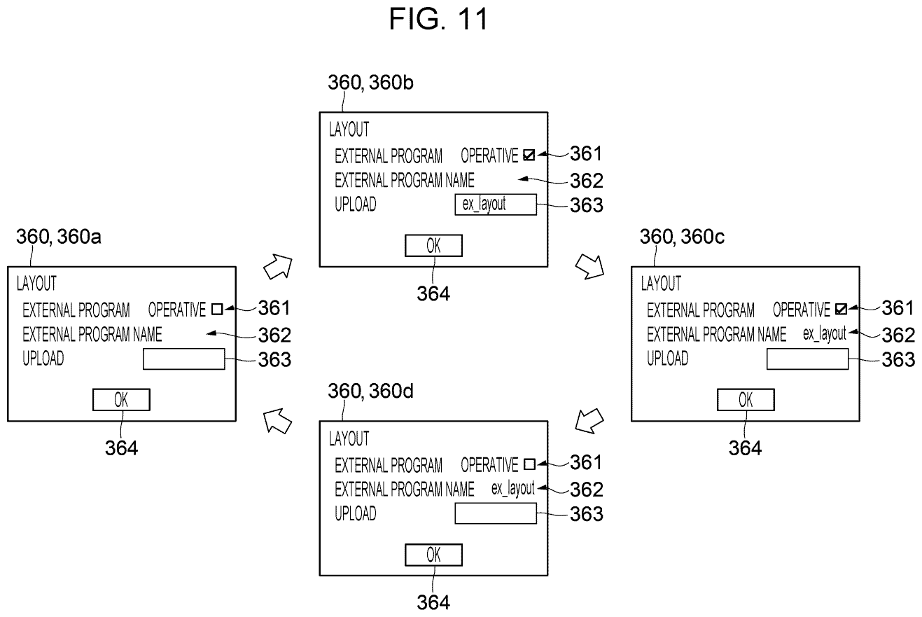

FIG. 11 illustrates an example of screens displayed by the image processing apparatus 300 of the third exemplary embodiment.

Referring to FIG. 11, the image processing apparatus 300 displays an external program registration screen 360 on the operation panel 15. The external program registration screen 360 is used to upload and then register the external program 350.

The image processing apparatus 300 may now display the external program registration screen 360 for the first time. The external program registration screen 360 looks like an external program registration screen 360a.

The user may now input information on the external program 350 to the external program registration screen 360a in this state. Specifically, the user may now check off a check box 361. The user may further input the name “ex_layout” of the external program 350 to an external program name input region 363. The external program registration screen 360 then looks like an external program registration screen 360b.

The user may now press an OK button 364 on the external program registration screen 360. The external program registration screen 360 may look like an external program registration screen 360c. Specifically, an external program name display region 362 displays the name “ex_layout” of the external program 350. The name of the external program 350 on the external program name input region 363 disappears.

In this state, the user may now uncheck the check box 361 on the external program registration screen 360. The external program registration screen 360 then looks like the external program registration screen 360d. Specifically, the check mark in the check box 361 disappears.

In this state, the user may now press the OK button 364 on the external program registration screen 360. The external program registration screen 360 then looks like the external program registration screen 360a. Specifically, the name of the external program 350 disappears on the external program name display region 362. The user may in this way upload and register another external program 350.

### Functional Configuration of Image Processing Apparatus

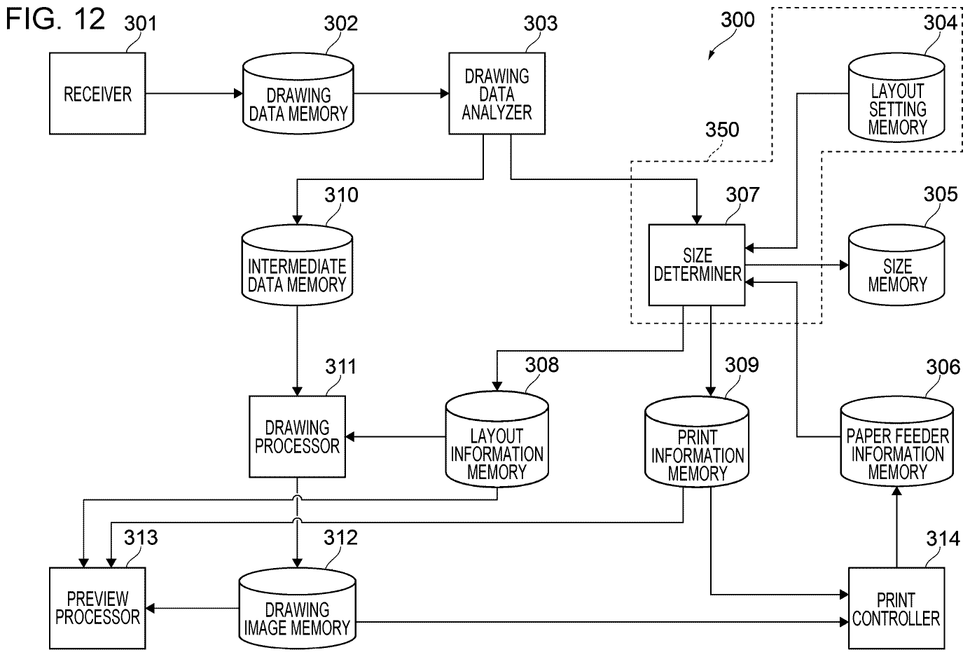

FIG. 12 illustrates an example of the functional configuration of the image processing apparatus 300 according to the third exemplary embodiment. Referring to FIG. 12, the image processing apparatus 300 includes a receiver 301, drawing data memory 302 and drawing data analyzer 303. The image processing apparatus 300 further includes a layout setting memory 304, size memory 305 and paper feeder information memory 306. The image processing apparatus 300 further includes a size determiner 307, layout information memory 308 and print information memory 309. The image processing apparatus 300 further includes an intermediate data memory 310 and drawing processor 311. The image processing apparatus 300 further includes a drawing image memory 312, preview processor 313 and print controller 314.

The functions of the elements of the image processing apparatus 300 are respectively identical to the functions of the corresponding elements of the image processing apparatus 100. The description of the functions of the elements of the image processing apparatus 300 is thus omitted herein.

According to the third example embodiment, as illustrated in FIG. 12, the size determiner 307 and layout setting memory 304 are implemented using the external program 350. The image processing apparatus 300 starts up the external program 350 instead of causing the size determiner 307 to operate. The external program 350 generates the layout information and print information from the size of the drawing data determined by the drawing data analyzer 303. The operation that generates the layout information and print information by starting up the external program 350 of the image processing apparatus 300 is an example of the operation that determines the information on the output paper sheet and the information on the print area by executing the external program 350.

### Detailed Process of Image Processing Apparatus

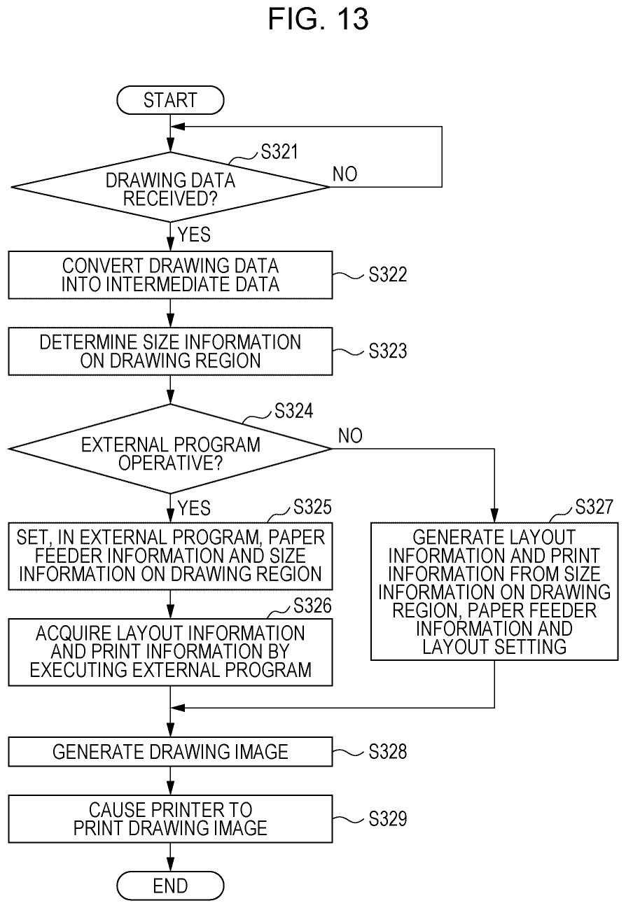

FIG. 13 is a flowchart illustrating an example of the process of the image processing apparatus 300 according to the third exemplary embodiment.

Referring to FIG. 13, the image processing apparatus 300 first determines whether the receiver 301 had received the drawing data (step S321). If the drawing data has not been received in step S321, the receiver 301 repeats step S321. If the drawing data has been received in step S321, the drawing data memory 302 stores the drawing data.

The drawing data analyzer 303 analyzes the drawing data stored on the drawing data memory 302. In this way, the drawing data analyzer 303 converts the drawing data into intermediate data (step S322). The intermediate data is stored on the intermediate data memory 310. The drawing data analyzer 303 determines the size information on the drawing region (step S323).

The image processing apparatus 300 determines whether the external program 350 is operative (step S324).

The external program 350 may now be operative in step S324. The image processing apparatus 300 loads the size information on the drawing region and feeder information on the external program 350 (step S325). The image processing apparatus 300 acquires the layout information and print information by performing the external program 350 (step S326). The layout information includes the magnification, offset potion, angle of rotation and the like when the drawing data is printed on the paper sheet. The layout information is stored on the layout information memory 308. The print information includes the information on the feeder 21, cut length when the paper is a rolled paper sheet, and the like. The print information is stored on the print information memory 309.

On the other hand, the external program 350 may be nonoperative in step S324. The size determiner 107 then generates the layout information and print information (step S327). Specifically, the size determiner 107 acquires the size information on the drawing region determined in step S123. The size determiner 107 retrieves the layout settings from the layout setting memory 104. The size determiner 107 retrieves the feeder information from the paper feeder information memory 106. The size determiner 107 generates the layout information and print information in accordance with these pieces of information. The layout information includes the magnification, offset potion, angle of rotation and the like used when the drawing data is printed on the paper sheet. The layout information is stored on the layout information memory 108. The print information includes the information on the feeder 21, cut length used when the paper is a rolled paper sheet, and the like. The print information is stored on the print information memory 109.

Subsequent to step S326 or step S327, the drawing processor 311 generates the drawing image (step S328). Specifically, the drawing processor 311 retrieves the intermediate data from the intermediate data memory 310. The drawing processor 311 retrieves the layout information from the layout information memory 308. The drawing processor 311 performs the vector-raster conversion in accordance with the intermediate data and layout information. The drawing processor 311 generates the drawing image by writing the raster image on the page memory. The drawing image is stored on the drawing image memory 312.

The print controller 314 then causes the printer 20 to print the drawing image (step S329) and ends the process.

The third example embodiment is free from the step of the preview processor 113 of generating and displaying the preview image. However, as in the same manner as in the first exemplary embodiment, the step of the preview processor 113 of generating and displaying the preview image may performed in the third exemplary embodiment. Specifically, the step may be performed subsequent to step S328.

If preview results are not as expected in the third exemplary embodiment, a simple change of the layout settings may not be a solution. The external program 350 may be switched instead of the simple change of the layout settings. In some cases, the external program 350 may be recreated and registered again. Since the flowchart becomes complex in such a case, the step of generating and displaying the preview image is omitted.

### Processor

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

### Program

The disclosure may be applied to a program and a program product. For example, the program and the program product according to the exemplary embodiments may cause a computer to implement the function of acquiring size information of a drawing region of drawing data that is produced without designating an output paper sheet, the function of acquiring layout settings designated in printing the drawing data, the function of generating, in response to the size information and the layout settings, an advance confirmation image used to confirm, in advance, information on an output paper sheet on which the drawing data is to be printed, and information on a print area of the drawing data on the output paper sheet.

The program of the exemplary embodiments may be delivered using a communication unit. The program of the exemplary embodiments may be delivered in a recorded form on a recording medium, such as a compact-disc read-only memory (CD-ROM).

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

An information processing system including:
a processor configured to:
   acquire size information indicating a size of a drawing region of drawing data that is produced without designating an output paper sheet;
   acquire layout settings designated in printing the drawing data; and
   generate, in response to the size information and the layout settings, an advance confirmation image used to confirm, in advance, information on the output paper sheet on which the drawing data is to be printed, and information on a print area of the drawing data on the output paper sheet.
(((2)))

In the information processing system according to (((1))), the processor is configured to:
acquire the drawing data; and
acquire the size information by analyzing the drawing data.
(((3)))

In the information processing system according to (((2))), the advance confirmation image includes a print image of the drawing data.
(((4)))

In the information processing system according to (((1))), the processor is configured to acquire the size information without acquiring the drawing data.
(((5)))

In the information processing system according to (((4))), the processor is configured to acquire the size information in response to a user operation that designates the size information.
(((6)))

In the information processing system according to (((4))), the processor is configured to acquire the size information associated with print data, selected by a user, from among past print data.
(((7)))

In the information processing system according to one of (((1))) through (((6))), the processor is configured to determine the information on the output paper sheet and the information on the print area by executing an external program.
(((8)))

In the information processing system according to one of (((1))) through (((7))), the advance confirmation image is used to confirm in advance, as the information on the output paper sheet, a size and an orientation of the output paper sheet.
(((9)))

In the information processing system according to one of (((1))) through (((7))), the advance confirmation image is used to confirm in advance, as the information on the output paper sheet, a size and a cut length of the output paper sheet.
(((10)))

In the information processing system according to one of (((1))) through (((9))), the advance confirmation image is used to confirm in advance, as the information on the print area, an orientation, a magnification, and a position in printing the drawing data on the output paper sheet.
(((11)))

In the information processing system according to one of (((1))) through (((10))), the advance confirmation image includes an image of a drawing frame of the drawing data.
(((12)))

A program causing a computer to execute a process, the process including:
acquiring size information indicating a size of a drawing region of drawing data that is produced without designating an output paper sheet;
acquiring layout settings designated in printing the drawing data; and
generating, in response to the size information and the layout settings, an advance confirmation image used to confirm, in advance, information on the output paper sheet on which the drawing data is to be printed, and information on a print area of the drawing data on the output paper sheet.

What is claimed is:

1. An information processing system comprising:
a processor configured to:
acquire size information indicating a size of a drawing region of drawing data that is produced without designating an output paper sheet;
acquire layout settings designated in printing the drawing data; and
generate, in response to the size information and the layout settings, an advance confirmation image used to confirm, in advance, information on the output paper sheet on which the drawing data is to be printed, and information on a print area of the drawing data on the output paper sheet.

2. The information processing system according to claim 1, wherein the processor is configured to:
acquire the drawing data; and
acquire the size information by analyzing the drawing data.

3. The information processing system according to claim 2, wherein the advance confirmation image comprises a print image of the drawing data.

4. The information processing system according to claim 1, wherein the processor is configured to acquire the size information without acquiring the drawing data.

5. The information processing system according to claim 4, wherein the processor is configured to acquire the size information in response to a user operation that designates the size information.

6. The information processing system according to claim 4, wherein the processor is configured to acquire the size information associated with print data, selected by a user, from among past print data.

7. The information processing system according to claim 1, wherein the processor is configured to determine the information on the output paper sheet and the information on the print area by executing an external program.

8. The information processing system according to claim 1, wherein the advance confirmation image is used to confirm in advance, as the information on the output paper sheet, a size and an orientation of the output paper sheet.

9. The information processing system according to claim 1, wherein the advance confirmation image is used to confirm in advance, as the information on the output paper sheet, a size and a cut length of the output paper sheet.

10. The information processing system according to claim 1, wherein the advance confirmation image is used to confirm in advance, as the information on the print area, an orientation, a magnification, and a position in printing the drawing data on the output paper sheet.

11. The information processing system according to claim 1, wherein the advance confirmation image comprises an image of a drawing frame of the drawing data.

12. A non-transitory computer readable medium storing a program causing a computer to execute a process, the process comprising:
acquiring size information indicating a size of a drawing region of drawing data that is produced without designating an output paper sheet;
acquiring layout settings designated in printing the drawing data; and
generating, in response to the size information and the layout settings, an advance confirmation image used to confirm, in advance, information on the output paper sheet on which the drawing data is to be printed, and information on a print area of the drawing data on the output paper sheet.

13. A method comprising:
acquiring size information indicating a size of a drawing region of drawing data that is produced without designating an output paper sheet;
acquiring layout settings designated in printing the drawing data; and
generating, in response to the size information and the layout settings, an advance confirmation image used to confirm, in advance, information on the output paper sheet on which the drawing data is to be printed, and information on a print area of the drawing data on the output paper sheet.
